(19) United States
(12) Patent Application Publication
(10) Pub. No.: US 2005/0021233 A1
(43) Pub. Date: Jan. 27, 2005

(54) Monitoring system particularly for determining a radiological or chemical occurrence

(76) Inventor: Alan Christensen, Manistee, MI (US)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/884,408

(22) Filed: Jul. 2, 2004

Related U.S. Application Data
(60) Provisional application No. 60/484,702, filed on Jul. 3, 2003.

(51) Int. Cl. G01W 1/00

(52) U.S. Cl. 702/3

(57) ABSTRACT

A remote monitoring system notifying existence of a determined event including such as radiological, chemical and meteorological events. The system includes a monitoring device capable of determining the existence of a specified event at a minimum threshold value. A data logging buffer unit is in operative communication with the monitoring device and is capable of buffering, at a preset time interval, an inputted packet of information. A relay unit, in operative communication with the data logging buffer unit, transmits information delivered from the buffer unit and a mobile phone unit is in communication with the cell relay control unit. A PC in operative communication with the mobile phone unit is operable, upon receiving encoded data from the phone unit, to transmit the data to any plurality of additional remote and networked monitoring systems.

### CROSS REFERENCE TO RELATED APPLICATIONS

The present invention claims the priority of U.S. Provisional Patent Application Ser. No. 60,484,702, filed Jul. 3, 2003, and entitled “Monitoring System Particularly for Determining a Radiological or Chemical Occurrence.”

### BACKGROUND OF THE INVENTION

1. Field of the Invention

The present invention discloses a system for combining any type of radiological (nuclear), chemical or other monitoring device with digital output capability, in combination with multiple and remotely positioned and networked monitoring stations. The network is capable of providing notification, to any or all of the networked systems, of a chemical or radiological occurrence recorded by any of the monitoring systems.

2. Description of the Prior Art

The prior art is well documented with examples of measurement apparatuses and devices, such as which are capable of detecting the existence of certain conditions from a remote location. A particular application of these devices is the detection of a specified alarm condition at the remote location and one conventional example of this is the home alarm system, whereby a central alarm server connects to a multitude of individual and remote located units.

A first example drawn from the known art is set forth in Yanagidaiara, U.S. Patent Application Publication No. 2003`/0073886 A1, which teaches the provision of one or more mobile unit stable state determining members, a biological condition detector which detects the biological condition of the operator of the mobile unit, and an operator stable state determining member which determines whether or not the operator is in a stable state based on the biological condition. A processor adopts biological information indicating the biological condition detected by the biological condition detector as valid biological information and executes at least one of analysis processing, record processing, and output processing of the biological information if it is determined that the mobile unit is in a stable state and that the operator is in a stable state.

Siegel, U.S. Patent Application Publication No. 2002/0193967 A1 teaches a computerized early warning network for biological events which includes data generation at points of sale (POS) units of a retail store or pharmacy. Such data includes information regarding purchase of various medicines which are available at the central server associated with the point of sale equipment. The database of purchases is periodically culled to extract information regarding the quantities of different types of medicines purchased in a given time period. With medicines of a type correlating to specific diseases, the computers of the health authorities evaluate the purchase information on a type-by-type basis and region-by-region basis to determine (likelihood of) occurrence of a biological event in any of the regions.

U.S. Pat. No. 4,141,006, issued to Braxton, teaches a security system for monitoring and reporting remote alarm conditions which includes a central digital processor (PC) to which are digitally connected (such as by phone) a plurality of remote units. Each of the remote units includes plural alarm sensors such as intrusion and heat sensors. A database located in the central processor includes data associated unique to each of the remote premises having the remote units. The processor system of Braxton further includes, among other features, a terminal for delivering alarm message reports, such as to law enforcement agencies, as well as interrogation circuitry for interrogating the sensors to determine if they have been tripped.

### SUMMARY OF THE PRESENT INVENTION

The present invention discloses a remote monitoring system for notifying the existence of a determined event including such as radiological, chemical and meteorological events. A monitoring device is capable of determining the existence of a specified event at a minimum threshold value. A data logging buffer unit is in operative communication with the monitoring device buffs, at a preset time interval, an inputted packet of information.

A relay unit is in operative communication with the data logging buffer unit, and transmits information delivered from the buffer unit. A mobile phone unit is in communication with the cell relay control unit and a PC is in operative communication with the mobile phone unit and is operable, upon receiving encoded data from the phone unit, to transmit the data to any plurality of additional remote and networked monitoring systems.

Additional features include a power module with battery backup for supplying the monitoring device, the data logging buffer unit, relay unit and mobile phone unit. At least one of a wireless or modem phone access is established between the system and the associated PC.

### BRIEF DESCRIPTION OF THE DRAWING

Reference will now be made to the attached drawing, when read in the following detailed description, wherein like reference numerals refer to like parts throughout the several views, and in which:

FIG. 1 is a schematic view of the monitoring system with digital output and networking capability according to the present invention.

### DETAILED DESCRIPTION OF THE PREFERRED EMBODIMENT

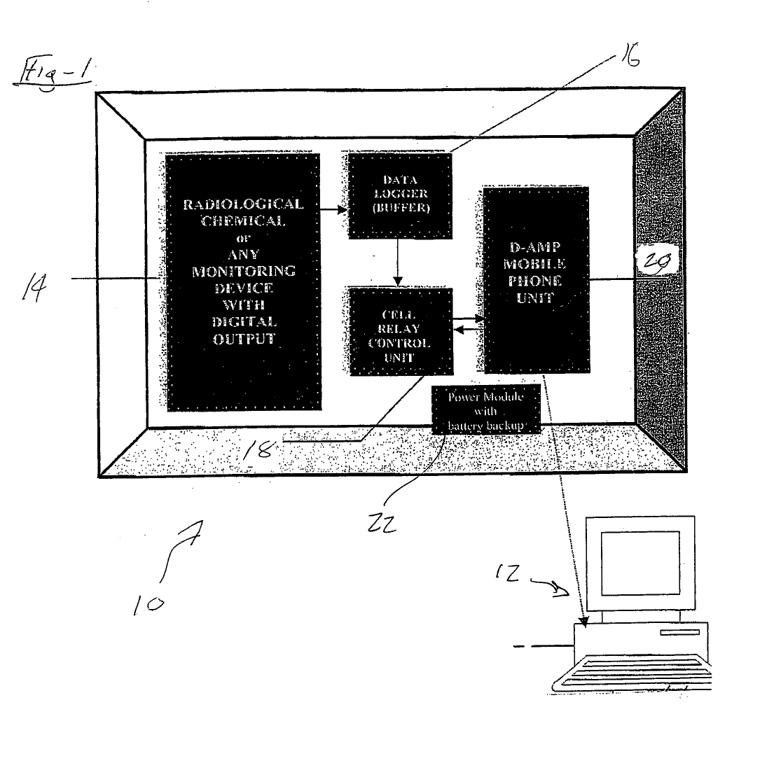

Referring to FIG. 1, an overall schematic of a monitoring system is illustrated at 10 according to the present invention. As explained previously, each monitoring system 10 is in individual communication with an associated PC (desktop or laptop computer) 12 and so that, upon networking together any plurality of systems, is capable of alerting any one (or all) of the systems of the existence of such as a chemical or radiological event.

Illustrated schematically at 14 is any known type of radiological, chemical or like monitoring device, and which incorporates some type of digital output capability. Each of the monitoring devices 14 are intended to be placed at locations such as chemical manufacturing facilities and industrial power plants (including such facilities which generate nuclear power). The monitoring devices 14 may also be located in areas of high vulnerability to chemical or radiological attack, these again including existing facilities, as well as areas of high military and civilian concentrations.

Operatively communicating with the monitoring device 14 is a data logger (buffer) 16 and which, in a preferred embodiment, exhibits the ability of buffering 1 minute, 10 minute, or 1 hour cell packets for a 1 hour period. Communicating with the logger/buffer 16 is a cell relay control unit 18 microprocessor, the purpose for which is to trigger appropriate cell packet encoding and transmission when requested or when triggered at a preset level.

The cell relay unit 18 operates in further conjunction with a D-Amp Mobile Phone Unit 20. The phone unit 20 operates to both receive requests from, as well as to transmit data packets to, any server or standalone PC (such as previously identified at 12). The PC is further provided with custom designed software to both send and receive the encoded data from the specified and remote monitoring system(s) 10. Also provided at 22 is a Power Module with battery backup which supplies power to the system 10.

In a preferred embodiment, each of the monitoring systems 10 are located at strategic locations (both within and without national boundaries) so that data can be obtained from any or all of the units as regularly obtained reports. Alternatively, the systems can be programmed to respond only to an alarm notification from any one given system 10 (and associated PC 12) which further has either wireless or modem phone access to the other networked systems.

It is also contemplated that the monitoring systems can also be calibrated to identify such as meteorological conditions, as well as any other type of data capable of being detected and digitized, within the scope of the invention. It is also contemplated that the data packets would include geographical coordinates, i.e., triplets (x, y, z), for use with geographical information system (GIS) files, in order to allow display of data directly on a map and/or aerial photograph at any of the PC workstations.

It is further contemplated that additional monitoring systems can be incorporated into an existing and operational system, with a minimum of additional effort, in order to introduce a measure of flexibility and upgradeability. It is still further contemplated that individual sub-pluralities of networked systems can be calibrated, within the scope of the invention, to identify any one of, or a plurality of, radiological, meteorological and chemical events.

Having described my invention, other additional preferred embodiments will become apparent to those skilled in the art to which it pertains without deviating from the scope of the appended claims.

1. A remote monitoring system for notifying the existence of a determined event including, without limitation, radiological, chemical and meteorological events, said system comprising:
a monitoring device capable of determining the existence of a specified event at a minimum threshold value;
a data logging buffer unit in operative communication with said monitoring device and capable of buffering, at a preset time interval, an inputted packet of information;
a relay unit, in operative communication with said data logging buffer unit, which transmits information delivered from said buffer unit;
a mobile phone unit in communication with said cell relay control unit; and
a PC in operative communication with said mobile phone unit and operable, upon receiving encoded data from said phone unit, to transmit said data to any plurality of additional remote and networked monitoring systems.

2. The remote monitoring system according to claim 1, further comprising a power module with battery backup for supplying said monitoring device, data logging buffer unit, relay unit and mobile phone unit.

3. The remote monitoring system according to claim 1, further comprising at least one of a wireless or modem phone access established between said system and said associated PC.

4. The remote monitoring system according to claim 1, said inputted packet of information further comprising a data packet exhibiting x, y, z geographical coordinates, for use with geographical information system files.

5. A remote monitoring system, comprising:
a monitoring device capable of determining the existence of a specified event at a minimum threshold value;
a buffer unit in operative communication with said monitoring device and buffering, at a preset time interval, an inputted packet of information;
a relay unit, in operative communication with said buffer unit, which transmits information delivered from said buffer unit to a mobile phone unit in communication with said relay unit; and
a PC and display, in operative communication with said mobile phone unit and operable, upon receiving encoded data from said phone unit, to transmit said data to any plurality of additional remote and networked monitoring systems.

6. A remote monitoring system, comprising:
at least one remotely located monitoring device capable of determining the existence of a specified event at a minimum threshold value;
a buffer unit in operative communication with said monitoring device and buffering, at a preset time interval, an inputted packet of information;
a relay unit, in operative communication with said buffer unit, which transmits information delivered from said buffer unit to a mobile phone unit in communication with said relay unit;
a power module for supplying said monitoring device, buffer unit, relay unit and mobile phone unit; and
a PC in operative communication with said mobile phone unit and, upon receiving encoded data from said phone unit, transmitting said data to any plurality of additional remotely located and networked monitoring systems.
